(19) United States
(12) Patent Application Publication
(10) Pub. No.: US 2019/0168244 A1
(43) Pub. Date: Jun. 6, 2019

(54) OSCILLATING SPRINKLER WITH ADJUSTABLE SPRAY AREA

(71) Applicant: NINGBO DAYE GARDEN INDUSTRY CO., LTD, Yuyao Ningbo (CN)

(72) Inventors: Xiaodong YE, Yuyao Ningbo (CN); Jifeng HUANG, Yuyao Ningbo (CN)

(73) Assignee: NINGBO DAYE GARDEN INDUSTRY CO., LTD, Yuyao Ningbo (CN)

(21) Appl. No.: 16/302,552

(22) PCT Filed: Jul. 19, 2016
(86) PCT No.: PCT/CN2016/090380

§ 371 Date: Nov. 16, 2018

(30) Foreign Application Priority Data
May 27, 2016 (CN) 201610359617.1

(51) Int. Cl. B05B 3/04; B05B 15/68

(52) U.S. Cl. CPC B05B 3/044; B05B 1/20; B05B 15/68

(57) ABSTRACT

The present invention discloses an oscillating sprinkler with an adjustable spray area, and relates to a gardening watering tool that obtains a spray area by swinging an ejected water flow by using a jet principle related to flow pressure. A structure of the oscillating sprinkler includes a base, an oscillating gear box, a spray assembly, and the like. An end portion of a spray tube of the spray assembly is mainly provided with water passage holes in communication with a water cavity in the spray tube and an adjusting jacket rotatably sleeved over the end portion of the spray tube and sealing the water passage holes. A plurality of rows of adjusting spray holes with different quantities is provided on the adjusting jacket, and the plurality of rows of adjusting spray holes can be in sequentially selective communication with the water passage holes with rotation of the adjusting jacket. Therefore, when original fixed spray holes on the spray tube and the adjusting spray holes that can be adjusted at the end portion of the spray tube are combined for use, the entire oscillating sprinkler has a function of controlling adjustment of the spray area. The improved oscillating sprinkler further has advantages such as simplicity in structure design, flexibility in adjustment operation, convenience in use, being capable of precisely controlling adjustment of the spray area, and low production costs.

### TECHNICAL FIELD

The present invention relates to an oscillating sprinkler in watering tools for garden greening, and specifically, to an oscillating sprinkler with an adjustable spray area.

### RELATED ART

An oscillating sprinkler is a common watering tool in garden greening, and sprays a coverage area by swing left and right in a range of 90 degrees mainly by using a jet principle related to flow pressure. Therefore, the oscillating sprinkler may be widely applied to irrigation and maintenance of gardens, nurseries, lawns, and the like, or may be applied to temperature reduction for building roofs, and also has obvious effects in scenarios such as pavement construction maintenance and dust and coal dust treatment. A common oscillating sprinkler is shown as the disclosed “Gardening Spray Apparatus” with the Chinese Patent No. 200720184467.1. A structure of the gardening spray apparatus mainly includes a base, a spray assembly mounted on the base, an oscillating gear box driving the spray assembly to swing, and the like. Such oscillating sprinkler has an unadjustable spray area, and a use function is limited. Currently, an oscillating sprinkler provided with an adjusting valve for adjusting a spray range is available on the market. During use, a spray range may be controlled depending on a spray area. Such oscillating sprinkler with an adjustable spray area satisfies use requirements of a user in various scenarios. However, additionally providing the adjusting valve on the oscillating sprinkler not only causes a structure design of the oscillating sprinkler more complex but also increases production costs. Especially, because an operation of the adjusting valve is a blind operation, it is difficult to precisely control an adjustment change of the spray area, and the spray range can only be roughly grasped. This also brings some inconvenience to use.

### SUMMARY

A technical problem to be resolved in the present invention is to overcome a disadvantage in the prior art and provide an oscillating sprinkler with an adjustable spray area which is simple in structure design, flexible in adjustment operation, convenient in use, and capable of precisely controlling adjustment of a spray area, and has low production costs.

The technical problem of the present invention is resolved by using the following technical solutions:

An oscillating sprinkler with an adjustable spray area includes a base, a spray assembly mounted on the base, and an oscillating gear box driving the spray assembly to swing. The spray assembly has a spray tube in which a water cavity is disposed, and a plurality of fixed spray holes in communication with the water cavity is provided on the spray tube. A water inlet end and a water outlet end that is in sealing communication with the water cavity are disposed on the oscillating gear box. An end portion of the spray tube is provided with water passage holes (312) in communication with the water cavity and an adjusting jacket rotatably sleeved over the end portion of the spray tube and sealing the water passage holes, a plurality of rows of adjusting spray holes is provided on the adjusting jacket, and the plurality of rows of adjusting spray holes is in sequentially selective communication with the water passage holes with rotation of the adjusting jacket.

The plurality of rows of adjusting spray holes includes a single-hole row having only one adjusting spray hole and a multi-hole row having 2 to 10 adjusting spray holes. The plurality of adjusting spray holes in the multi-hole row is arranged in line in an axial direction of the adjusting jacket.

The end portion of the spray tube refers to a head of the spray tube or a tail of the spray tube, and the adjusting jacket is rotatably sleeved over the head of the spray tube or the tail of the spray tube, or over both the head and the tail of the spray tube.

The water passage hole is a counterbore in communication with the water cavity, a sealing ring is embedded in the counterbore, and the sealing ring comes into contact with an inner surface of the adjusting jacket and provides communication sealing for the water passage hole and the adjusting spray hole.

Positioning balls exposed when being elastically pushed are disposed on an outer surface of the end portion of the spray tube, and a plurality of positioning slots distributed evenly on a circumference for fitting and rolling of the positioning balls is correspondingly disposed on an inner surface of the adjusting jacket.

A quantity of the positioning slots is the same as a quantity of rows of the adjusting spray holes.

The plurality of fixed spray holes is arranged in line in an axial direction of the spray tube.

A plug shaft for sealing mounting is plugged inside the tail of the spray tube, and the plug shaft is rotatably mounted on the base.

A connection sleeve is disposed between the oscillating gear box and the head of the spray tube; the oscillating gear box drives, by using the connection sleeve, the spray assembly to swing; the water inlet end is disposed at one end of the oscillating gear box; and an oscillating output shaft is disposed at the other end of the oscillating gear box. The oscillating output shaft is set to a hollow shaft, and an end portion of the hollow shaft is set to the water outlet end.

An elastic engagement plate is disposed at the bottom of the oscillating gear box, and an engagement hole is correspondingly disposed on a top surface of the base. The elastic engagement plate is detachably inserted into the engagement hole.

Compared with the prior art, in the present invention, an end portion of a spray tube of the spray assembly is mainly provided with water passage holes (312) in communication with a water cavity in the spray tube and an adjusting jacket rotatably sleeved over the end portion of the spray tube and sealing the water passage holes. A plurality of rows of adjusting spray holes with different quantities is provided on the adjusting jacket, and the plurality of rows of adjusting spray holes can be in sequentially selective communication with the water passage holes with rotation of the adjusting jacket. Therefore, when original fixed spray holes on the spray tube and the adjusting spray holes that can be adjusted at the end portion of the spray tube are combined for use, the entire oscillating sprinkler has a function of controlling adjustment of the spray area. The improved oscillating sprinkler further has advantages such as simplicity in structure design, flexibility in adjustment operation, convenience in use, being capable of precisely controlling adjustment of the spray area, and low production costs.

### BRIEF DESCRIPTION OF THE DRAWINGS

FIG. 1 is a schematic structural diagram according to the present invention;

FIG. 2 is a three-dimensional exploded diagram of FIG. 1; and

FIG. 3 is a three-dimensional exploded diagram of a spray assembly.

### DETAILED DESCRIPTION

The following further describes embodiments of the present invention in detail with reference to the accompanying drawings.

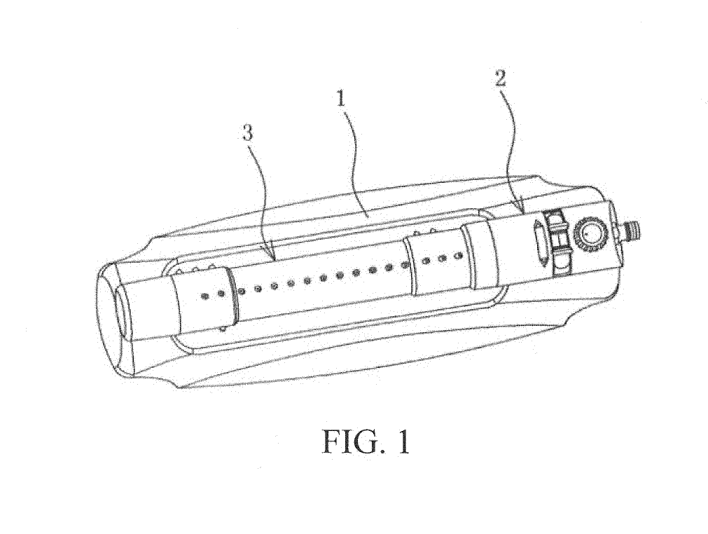

As shown in FIG. 1 to FIG. 3: 1: Base; 11: Groove; 12: Shaft seat; 13: Engagement hole; 2: Oscillating gear box; 21: Water inlet end; 22: Water outlet end; 23: Elastic engagement plate; 3: Spray assembly; 31: Spray tube; 311: Fixed spray hole; 312: Water passage holes; 313: Water cavity; 314: Shoulder; 32: Adjusting jacket; 321: Adjusting spray holes; 322: Positioning slot; 33: Sealing ring; 34: Plug shaft; 35: Connection sleeve; 36: Spring; and 37: Positioning ball.

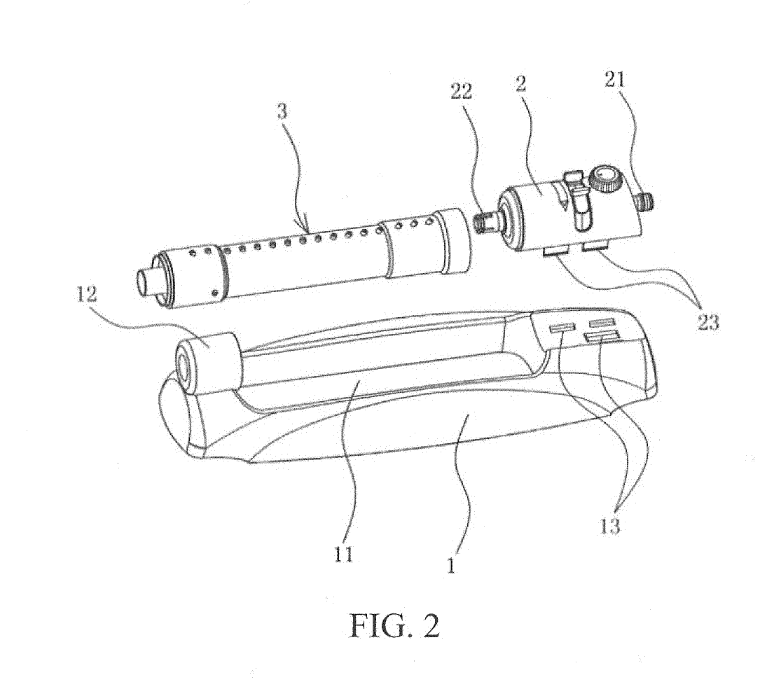

As shown in FIG. 1 and FIG. 2, an oscillating sprinkler with an adjustable spray area obtains a coverage spray area by swinging an ejected water flow left and right in a range of 90 degrees by using a jet principle related to flow pressure, so as to facilitate irrigation and maintenance of gardens, nurseries, lawns, and the like, temperature reduction for building roofs, pavement construction maintenance and dust and coal dust treatment, or the like.

The oscillating sprinkler is mainly formed by three components: a base 1, a spray assembly 3, and an oscillating gear box 2. According to a daily actual use status, the embodiments are described in detail by using a left side of a view shown in FIG. 1 as a tail of the entire oscillating sprinkler and a right side of the view as a head of the entire oscillating sprinkler.

The base 1 is a basis of mounting the entire oscillating sprinkler. Depending on aesthetics and different use scenarios, an appearance of the oscillating sprinkler may be designed in a plurality of ways, but is roughly in a long strip form and has a flat large bottom surface for stable mounting on land or a support. A top surface of the base 1 is used for mounting the spray assembly 3 and the oscillating gear box 2. To keep a stable center of gravity, an extension area of the top surface of the base 1 is not designed to be very large. In addition, the spray assembly 3 is generally designed to be a tube structure. Therefore, considering mounting of the spray assembly 3, a groove 11 is usually disposed in advance in an axial direction of the base 1 on the top surface of the base 1, so that the spray assembly 3 forms a semi-enclosed mounting structure with the top opened.

The oscillating gear box 2 is disposed, at a head of the base 1. Specifically, three elastic engagement plates 23 are disposed at the bottom of the oscillating gear box 2, and several engagement holes 13 are corresponding disposed on the top surface of the base 1. Each elastic engagement plate 23 corresponds to one engagement hole 13 for detachable insertion, so that connection mounting is formed between the oscillating gear box 2 and the base 1.

A water inlet end 21 is disposed on a right side of the oscillating gear box 2, and may be used for externally connecting to a water inlet tube and providing a water source for the entire oscillating sprinkler. An oscillating output shaft is disposed on a left side of the oscillating gear box 2. The oscillating output shaft is set to a hollow shaft, and an end portion of the hollow shaft is set to a water outlet end 22. In addition, the oscillating gear box 2 is designed to be an adjustable structure. That is, an oscillation angle, oscillation frequency, oscillation amplitude, and the like can be adjusted, to satisfy an actual use requirement

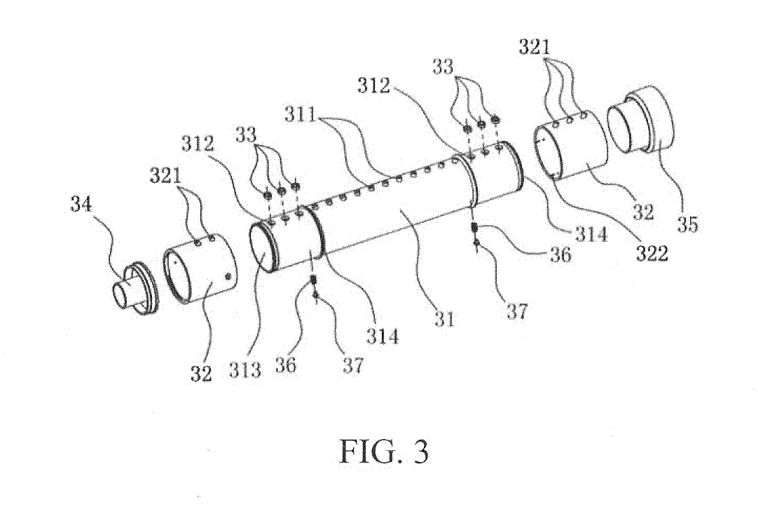

The spray assembly 3 is shown in FIG. 3, and includes a cylindrical tubular spray tube 31. A plug shaft 34 for sealing mounting is plugged inside a tail of the spray tube. The plug shaft, as a support shaft at one end of the spray tube 31, is rotatably mounted in a shaft seat 12 disposed on the base 1 in advance. A connection sleeve 35 is disposed between a head of the spray tube 3 and the oscillating gear box 2, and the oscillating gear box 2 drives the spray tube 31, that is, the spray assembly 3, by using the connection sleeve 35 to perform a swing action. The connection sleeve 35 also plays a supporting role for the other end of the spray tube 31.

The spray tube 31 has a hollow interior to form a water cavity 313. When the spray tube 31 connects to the oscillating gear box 2 by using the connection sleeve 35, the water outlet end 22 on the oscillating gear box is in sealing communication with the water cavity 313 to supply water. Several fixed spray holes 311 are provided on a top surface of the spray tube 31. As shown in FIG. 1, 11 fixed spray holes 311 may be provided. The several fixed spray holes 311 are equidistantly arranged in line in an axial direction of the spray tube 31. Therefore, water flows ejected from the several fixed spray holes can form a water curtain, and a spray area can be covered when the spray tube 31 swings. Therefore, a size of the spray area is related to an arrangement width of the fixed spray holes 311. A quantity of set fixed spray holes 311 is not limited, and is generally adjusted according to an actual situation, such as a change of a spray site or a design size of the oscillating sprinkler.

The end portion of the spray tube 31 is provided with a plurality of water passage holes 312 in communication with the water cavity 313. The plurality of water pas′sage holes is arranged in line in the axial direction of the spray tube 31. An adjusting jacket 32 rotatably sleeved over the end portion of the spray tube 31 and sealing the water passage holes 312 is further disposed at the end portion of the spray tube 31. Shoulders 314 are disposed on the spray tube 31 at two ends of the adjusting jacket for blocking, to avoid, axial motion of the adjusting jacket 32. In the embodiments, the end portion of the spray tube 31 mainly refers to a head of the spray tube or a tail of the spray tube. In an actual structure design, mounting of the adjusting jacket 32 at the end portion of the spray tube 31 is specifically that the adjusting jacket 32 is rotatably sleeved over the head of the spray tube or the tail of the spray tube, or over both the head and the tail of the spray tube.

The water passage hole 312 is designed to be a counterbore in communication with the water cavity 313, and a sealing ring 33 is embedded in the counterbore. A plurality of rows of adjusting spray holes 321 is provided on the adjusting jacket 32. According to a design in an actual working situation, the plurality of rows of adjusting spray holes 321 may be a single-hole row having only one adjusting spray hole or a multi-hole row having 2 to 10 adjusting spray holes. A plurality of adjusting spray holes in each multi-hole row is arranged in line in an axial direction of the adjusting jacket 32. A quantity of the water passage holes 312 at the end portion of the spray tube 31 is usually designed to be the same as, a maximum quantity of adjusting spray holes 321 in a multi-hole row.

In the embodiments, three water passage holes 312 equidistantly arranged in line are designed at the end portion of the spray tube 31, and three rows of adjusting spray holes 321 are provided on the adjusting jacket 32, which are one adjusting spray hole, two adjusting spray holes arranged in line and three adjusting spray holes arranged in line. When the adjusting jacket 32 is rotated, the three rows of adjusting spray holes 321 are in sequentially selective communication with the water passage holes 312 at the end portion of the spray tube 31. The sealing ring 33 in the water passage hole 312 comes into contact with an inner surface of the adjusting jacket 32 and provides communication sealing for the water passage hole 312 and the adjusting spray hole 321.

For example, when the adjusting jacket 32 is rotated to the row with one adjusting spray hole 321, the adjusting spray hole can be in sealing communication with only one of the water passage holes 312, and the other two water passage holes are closed. In this case, a spray area width of only one spray hole is increased by combining the adjusting spray hole 321 with the fixed spray hole 311. When the adjusting jacket 32 is rotated to the row with three adjusting spray holes 321, the three adjusting spray holes are in sealing communication with all of the three water passage holes 312. Therefore, a spray area width of three spray holes can be increased by combining the adjusting spray holes 321 with the fixed spray holes 311. In this case, a maximum spray area can be obtained through adjustment in the embodiments. When the adjusting jacket 32 is rotated to a position at which all of the water passage holes 312 are closed, the adjusting spray holes play no roles, and the entire sprinkler can determine a spray area depending only on the fixed spray hole 311. In this case, a minimum spray area can be obtained through adjustment in the embodiments. Therefore, as shown in FIG. 1, in an example in which two adjusting jackets 32 are rotatably sleeved over the head and the tail of the spray tube 31 respectively, the two adjusting jackets can rotate and coordinate relative to each other to enable the oscillating sprinkler to have more combination changes in the spray area.

To precisely positioning, a rotation position of the adjusting jacket 32 relative to the spray tube 31, to control a change in adjustment of the spray area, positioning balls 37 exposed when being elastically pushed by a spring 36 are further disposed on an outer surface of the end portion of the spray tube 31, and a plurality of positioning slots 322 distributed evenly on a circumference for fitting and rolling of the positioning balls is correspondingly disposed on an inner surface of the adjusting jacket 32. A quantity of the positioning slots is usually designed to be the same as a quantity of rows of the adjusting spray holes 321. In this case, a rotation angle of the adjusting jacket 32 can be precisely positioned by using each positioning slot 322, and the water passage holes 312 are closed or one row of adjusting spray holes 321 can be used. Therefore, through fitting between the positioning balls 37 and the positioning slots 322, operations of the adjusting jacket 32 are less laborious, and adjustment and positioning of the spray area are more accurate.

The present invention belongs to a rectangular oscillating spraying manner, where oscillating amplitude can be adjusted. When the present invention is applied to gardening irrigation and spraying, a spray area can be randomly adjusted based on a garden size, thereby greatly facilitating users to use.

The foregoing descriptions are only specific embodiments of the present invention, and a person skilled in the art should understand that a design having a structure similar to that in the present invention shall fall within the protection scope of the present invention.

What is claimed is:

1. An oscillating sprinkler with an adjustable spray area, comprising, a base (1), a spray assembly (3) mounted on the base (1), and an oscillating gear box (2) driving the spray assembly (3) to swing, wherein the spray assembly (3) has a spray tube (31) in which a water cavity (313) is disposed, and a plurality of fixed spray holes (311) in communication with the water cavity (313) is provided on the spray tube; a water inlet end (21) and a water outlet end (22) that is in sealing communication with the water cavity (313) are disposed on the oscillating gear box (2); and an end portion of the spray tube (31) is provided with water passage holes (312) in communication with the water cavity (313) and an adjusting jacket (32) rotatably sleeved over the end portion of the spray tube (31) and sealing the water passage holes (312), a plurality of rows of adjusting spray holes (321) is provided on the adjusting jacket, and the plurality of rows of adjusting spray holes is in sequentially selective communication with the water passage holes (312) with rotation of the adjusting jacket (32).

2. The oscillating sprinkler with an adjustable spray area according to claim 1, wherein the plurality of rows of adjusting spray holes (321) comprises a single-hole row having only one adjusting spray hole and a multi-hole row having 2 to 10 adjusting spray holes; and the plurality of adjusting spray holes (321) in the multi-hole row is arranged in an axial direction of the adjusting jacket (32).

3. The oscillating sprinkler with an adjustable spray area according to claim 1, wherein the end portion of the spray tube (31) refers to a head of the spray tube or a tail of the spray tube, and the adjusting jacket (32) is rotatably sleeved over the head of the spray tube or the tail of the spray tube, or two adjusting jackets (32) are rotatably sleeved on the head and the tail of the spray tube respectively.

4. The oscillating sprinkler with an adjustable spray area according to claim 1, wherein the water passage hole (312) is a counterbore in communication with the water cavity (313), a sealing ring (33) is embedded in the counterbore, and the sealing ring comes into contact with an inner surface of the adjusting jacket (32) and provides communication sealing for the water passage hole (312) and the adjusting spray hole (321).

5. The oscillating sprinkler with an adjustable spray area according to claim 1, wherein positioning balls (37) exposed when being elastically pushed are disposed at the end portion of the spray tube (31), and a plurality of positioning slots (322) for fitting and rolling of the positioning balls (37) is correspondingly disposed on the adjusting jacket (32).

6. The oscillating sprinkler with an adjustable spray area according to claim 5, wherein a quantity of the positioning slots (322) is the same as a quantity of rows of the adjusting spray holes (321).

7. The oscillating sprinkler with an adjustable spray area according to claim 1, wherein the plurality of fixed spray holes (311) is arranged in an axial direction of the spray tube (31).

8. The oscillating sprinkler with an adjustable spray area according to claim 1, wherein a plug shaft (34) for sealing mounting is plugged inside the tail of the spray tube (31), and the plug shaft is rotatably mounted on the base (1).

9. The oscillating sprinkler with an adjustable spray area according to claim 1, wherein a connection sleeve (35) is disposed between the oscillating gear box (2) and the head of the spray tube (31); the oscillating gear box (2) drives, by using the connection sleeve (35), the spray assembly (3) to swing; the water inlet end (21) is disposed at one end of the oscillating, gear box (2) and an oscillating output shaft is disposed at the other end of the oscillating gear box (2), wherein the oscillating output shaft is set to a hollow shaft, and an end portion of the hollow shaft is set to the water outlet end (22).

10. The oscillating sprinkler with an adjustable spray area according to claim 1, wherein an elastic engagement plate (23) is disposed at the bottom of the oscillating gear box (2), and an engagement hole (13) is correspondingly disposed on a top surface of the base (1), wherein the elastic engagement plate (23) is detachably inserted into the engagement hole (13).
